(19) United States
(12) Patent Application Publication
(10) Pub. No.: US 2024/0125744 A1
(43) Pub. Date: Apr. 18, 2024

(54) THERMALLY COUPLING THERMOSTATS OF A SEPARATION UNIT AND A SAMPLE HANDLING UNIT

(71) Applicant: Agilent Technologies, Inc., Santa Clara, CA (US)

(72) Inventors: Blasius Nocon, Rheinstetten (DE); Lena Höninger, Karlsruhe (DE); Christoph Geiger, Birkenfeld (DE); Axel Reichert, Woerth am Rhein (DE); Dirk Göger, Pfinztal (DE)

(21) Appl. No.: 18/379,930

(22) Filed: Oct. 13, 2023

(30) Foreign Application Priority Data
Oct. 18, 2022 (DE) 10 2022 127 329.6

(51) Int. Cl. G01N 30/30; G01N 30/12

(52) U.S. Cl. CPC G01N 30/30; G01N 30/12; G01N 2030/027

(57) ABSTRACT

A thermostat arrangement for a sample separation device for separating a fluidic sample includes a separation unit thermostat unit for adjusting a temperature of a separation unit for separating the fluidic sample in a mobile phase, a sample handling unit thermostat unit for adjusting the temperature of a sample handling unit for handling the fluidic sample, and a thermal coupling unit for thermally coupling the separation unit thermostat unit with the sample handling unit thermostat unit.

### CROSS-REFERENCE TO RELATED APPLICATIONS

This application claims priority under 35 U.S.C. § 119(a) to German Application No. DE 10 2022 127 329.6, filed on Oct. 18, 2022; the entire contents of which are incorporated by reference herein.

### TECHNICAL FIELD

The present invention relates to a thermostat arrangement, a sample separation device, and a method for separating a fluidic sample.

### BACKGROUND

In an HPLC, typically a liquid (mobile phase) is moved at a very precisely controlled flow rate (for example in the range of microliters to milliliters per minute) and at a high pressure (typically 20 to 1000 bar and more, currently up to 2000 bar), where the compressibility of the liquid is noticeable, through a so-called stationary phase (for example in a chromatographic column), to separate single components of a sample liquid from each other which is introduced in the mobile phase. Such an HPLC-system is known from EP 0,309,596 B1 of the same applicant, Agilent Technologies, Inc., for example.

In a chromatographic sample separation device, a chromatographic column, as example for a separation unit, is frequently arranged in a column oven in which the column is tempered. The fluidic sample to be separated may be injected via a sample insertion unit in a mobile phase, wherein a thermostat of the sample insertion unit controls the thermal conditions which are present there. In a sample storage unit, such as a microtiter plate, fluidic samples may be stored in a cooled manner, for example prior to the transfer into a sample insertion unit. The energetic effort for adjusting the temperature in a sample separation device is conventionally high. Moreover, the failure of one of the thermostats in a sample separation device may lead to undesired consequences, for example to destruction of a temperature-sensitive sample or to an unsuitability of a separation run.

### SUMMARY

It is an object of the invention to control the temperature of a sample separation device in a reliable and energy-saving manner.

According to an exemplary embodiment of the present disclosure, a thermostat arrangement for a sample separation device for separating a fluidic sample is provided, wherein the thermostat arrangement comprises a separation unit thermostat unit for adjusting the temperature of a separation unit for separating the fluidic sample in a mobile phase, a sample handling unit thermostat unit for adjusting the temperature of a sample handling unit for handling the fluidic sample, and a thermal coupling unit for thermally coupling the separation unit thermostat unit with the sample handling unit thermostat unit.

According to another exemplary embodiment, a sample separation device for separating a fluidic sample is provided, wherein the sample separation device comprises a fluid drive for driving a mobile phase and the fluidic sample which is located therein, a thermostat arrangement with the above described features, a separation unit which is temperable by the separation unit thermostat unit, for separating the fluidic sample in the mobile phase, and a sample handling unit which is temperable by the sample handling unit thermostat unit, for handling the fluidic sample.

According to yet another exemplary embodiment, a method for separating a fluidic sample is provided, wherein the method comprises handling the fluidic sample using a sample handling unit which is tempered by a sample handling unit thermostat unit, driving a mobile phase and the fluidic sample which is located therein by a fluid drive, separating the fluidic sample in the mobile phase using a separation unit which is tempered by a separation unit thermostat unit, and thermally coupling the separation unit thermostat unit with the sample handling unit thermostat unit (in particular by a thermal coupling unit).

According to yet another exemplary embodiment, a thermostat arrangement with the above-described features is used in the chromatography, in particular in the liquid chromatography (such as in the high-temperature liquid chromatography or in the subcritical water chromatography).

In the context of the present application, the term “sample separation device” may in particular denote a device which is capable and configured to separate a fluidic sample, in particular into different fractions. In the context of the sample separation, the fluidic sample may be injected in a mobile phase. For example, the sample separation may be performed by chromatography or electrophoresis. The sample separation device may be a liquid chromatography sample separation device, for example an HPLC.

In the context of the present application, the term “fluid” in particular denotes a liquid and/or a gas, optionally comprising solid body particles.

In the context of the present application, the term “fluidic sample” in particular denotes a medium, further in particular a liquid, which contains the material to be actually analyzed (for example a biological sample), such as a protein solution, a pharmaceutical sample, etc.

In the context of the present application, the term “mobile phase” in particular denotes a fluid, further in particular a liquid, which serves as a carrier medium for transporting the fluidic sample between a fluid drive and a separation unit. For example, the mobile phase may be a (for example organic and/or inorganic) solvent or a solvent composition (for example water and ethanol).

In the context of the present application, the term “fluid drive” in particular denotes a unit for conveying the mobile phase and the fluidic sample. In particular, the fluid drive may comprise a piston pump. The fluid drive may be configured as a fluid pump for generating a high pressure (for example at least 1000 bar) for conveying the mobile phase and the fluidic sample during the separation. The fluid drive may be configured as an analytical pump in the sample separation device.

In the context of the present application, the term “separation unit” may in particular denote a unit for separating a fluidic sample, in particular into different fractions. For this purpose, constituents of the fluidic sample may at first be adsorbed at the separation unit (also denoted as sample separation unit) and may then be separately desorbed (in particular in fractions). For example, such a separation unit may be configured as a chromatographic separation column.

The context of the present application, the term “separation unit thermostat unit” in particular denotes a unit for influencing, controlling, or regulating a temperature of a separation unit which is thermally coupled with the separation unit thermostat unit. In particular, the separation unit thermostat unit may be a temperature controller which, for example by a temperature sensor, captures an actual value at the separation unit or in a tempering chamber, and, by adapting a heat supply or cooling supply to the separation unit or in the tempering chamber, adjusts its temperature or the temperature in the tempering chamber to a (for example predetermined) target value. For example, a target value which is adjusted by a separation unit thermostat unit may be in a range from 70° C. to 90° C., for example at 80° C. For example, the heat supply or cooling supply may be accomplished in the separation unit thermostat unit by a heating- and/or cooling element, for example a Peltier-element. A Peltier-element may be a component where applying an electric current of a certain current direction leads to a heating or cooling. Therefore, a Peltier-element is especially suitable for adjusting or regulating a temperature, as it can be used for both cooling and heating. In particular, in some embodiments, the separation unit or the tempering chamber may be adjusted to a target temperature above the ambient temperature. In particular, in a liquid chromatography sample separation device, the accuracy and/or the reproducibility of the sample separation and the reliability in operation at an elevated temperature of a chromatographic separation column may be especially good. In an alternative embodiment, it is also possible to adjust the separation unit to a target temperature below the ambient temperature.

In the context of the present application, the term “sample handling unit” in particular denotes an arrangement which is adapted for handling a fluidic sample. For example, such a sample handling unit may comprise an injector or a sample insertion unit which is adapted for injecting a fluidic sample in a separation path for separating the fluidic sample in the separation path. Alternatively or additionally, such a sample handling unit may comprise a sample storing unit in which a fluidic sample to be separated may be stored prior to the separation, for example cooled in a sample carrier which is filled with sample containers. Further alternatively or additionally, a sample handling unit may comprise a fractionator or a part of it, by which a fluidic sample can be fractionized after the separation, for example can be filled in different target containers in fractions.

In the context of the present application, the term “sample handling unit thermostat unit” in particular denotes a unit for influencing, controlling, or regulating a temperature of a sample handling unit which is thermally coupled with the sample handling unit thermostat unit. In particular, the sample handling unit thermostat unit may be a temperature controller which, for example by a temperature sensor, captures an actual value at the sample handling unit and, by adapting a heat supply or a cooling supply to the sample handling unit, adjusts its temperature to a (for example predetermined) target value. For example, a target value which is adjusted by a sample handling unit thermostat unit of a fluidic sample which is stored, to be introduced in a separation path, or is in fractions, may be in a range from 5° C. to 20° C., for example at 10° C. The heat supply or the cooling supply may be accomplished in the sample handling unit thermostat unit by a heating- and/or cooling element, for example a compression refrigerating machine (which may also be configured for a selective operation as a heat pump). In particular, in some embodiments, the sample handling unit may be adjusted to a target temperature below the ambient temperature. This may be performed for cooling temperature-sensitive fluidic samples, for example. In an alternative embodiment, it is also possible to adjust the sample handling unit to a target temperature above the ambient temperature, for example to promote chemical reactions of the fluidic sample.

In the context of the present application, the term “thermal coupling unit” in particular denotes a physical entity which can accomplish a defined thermal coupling (in particular a thermally conductive connection) between a separation unit thermostat unit and a sample handling unit thermostat unit. The thermal coupling unit can thermally couple the separation unit thermostat unit and the sample handling unit thermostat unit either permanently or in a controlled or regulated manner (respectively stepless or according to an on-off-logic, for example). In a controllable, in particular regulatable, thermal coupling unit, it may be also selectively operated, such that a thermal coupling between the separation unit thermostat unit and the sample handling unit thermostat unit is at least partially prevented. However, a thermal coupling unit may also be configured to be purely passive, i.e., as a permanent thermal coupling between the thermostat units. By the thermal coupling unit, a heat flow between the separation unit thermostat unit and the sample handling unit thermostat unit may be enabled in a specific or well-defined manner. For example, the thermal coupling unit may accomplish the transfer of heat or coldness between the thermostat units by a heat- or coldness-carrying fluid (for example a liquid, such as water, or a gas, such as air) by a thermally highly conductive solid body structure (for example a metal rail made of aluminum or copper) and/or by another thermally coupling component (for example a heat pipe).

According to an exemplary embodiment of the present disclosure, a sample separation device can be equipped with a separation unit thermostat unit for adjusting the temperature of a separation unit (in particular for heating a separation column) and with a sample handling unit thermostat unit for adjusting the temperature of a sample handling unit (in particular for cooling a sample storing unit and/or a sample insertion unit). Advantageously, a corresponding thermostat arrangement may be provided with a thermal coupling unit which may establish a specific and controllable or even regulatable thermally conductive coupling between the thermostat units. In contrast to conventional approaches, different thermostat units of a sample separation device may thus not be operated separately from each other, but may be brought in a heat- or coldness exchange interaction by a thermal coupling unit which specifically connects them in a controllable manner. By a thermostat arrangement according to an embodiment of the present disclosure, it is possible to control the temperature of a sample separation device in a reliable and energy-saving manner. The increased reliability results from the fact that even in case of a failure or overload of one of the thermally coupled thermostat units, the respectively other one of the thermally coupled thermostat units can provide heat or coldness to the failed or overloaded thermostat unit, to maintain its target operation. Therefore, by the thermal coupling of the thermostat units, a redundant tempering system may be provided, whereby the entire thermostat arrangement may be designed in a more error-robust manner. In particular, due to the thermal coupling, one of the thermostat units may provide heat or coldness to another one of the thermostat units, when the latter shall perform a tempering task which overwhelms the capacity of this thermostat unit for providing heat or coldness. The delta of heat or coldness which exceeds this capacity may then be contributed by the thermally coupled other thermostat unit. Moreover, according to an exemplary embodiment of the present disclosure, in an advantageous manner, an especially energy-saving operation of a sample separation device with multiple thermostat units may be enabled, since waste heat and/or waste coldness from one of the thermostat units may be supplied to another thermostat unit which is thermally coupled with it by the thermal coupling unit in a defined manner.

In the following, additional embodiments of the thermostat arrangement, the sample separation device, and the method are described.

In an embodiment, a heat exchange between an injector thermostat unit (as example for the sample handling unit thermostat unit) and a separation column thermostat unit (as example for the separation unit thermostat unit) may be enabled in an advantageous manner. In particular, waste heat of the injector thermostat unit may be supplied to the separation column thermostat unit. Further in particular, it may be advantageously enabled to heat a heat exchanger which is attached at the separation column thermostat unit, for example, of the thermal coupling unit by the waste heat of the injector. In particular, this heat exchanger may be, for example externally, attached to a column oven for forming a thermal coupling. Alternatively, for this purpose, it is also possible to directly heat the separation unit (for example a chromatography separation column) and/or a preheating unit (also denoted as preheater) by the waste heat of the injector thermostat unit, for preheating the mobile phase before reaching the separation unit. Said heat exchanger may in turn be thermally coupled with the separation unit and, if present, the preheating unit.

According to an embodiment, the sample handling unit thermostat unit for adjusting the temperature of the sample handling unit for handling the fluidic sample before inserting the fluidic sample may be formed in a fluidic path between a fluid drive and the separation unit. Thus, the sample handling unit may accomplish handling the fluidic sample prior to a start of a (in particular chromatographical) separation run. Such a sample handling unit may in particular comprise a sample insertion unit which is described in more detail below (in particular for sucking and subsequently injecting a fluidic sample to be separated) and/or a sample storing unit (in particular for storing a fluidic sample before sucking in a sample insertion unit). In the phase before inserting or injecting in a separation path, it may be advantageous to cool the fluidic sample for its protection against a destabilization. This may be performed by the sample handling unit thermostat unit which may be adapted for adjusting a temperature of the sample handling unit and a fluidic sample which is located therein.

According to an embodiment, the sample handling unit thermostat unit may be adapted for adjusting the temperature of a sample insertion unit of the sample handling unit, wherein the sample insertion unit may be adapted for inserting the fluidic sample in a fluidic path between a fluid drive and the separation unit. In other words, the sample handling unit thermostat unit may be adapted to control the temperature of an injector or a sample insertion unit for injecting a received fluidic sample in a separation path such as a chromatographic separation path. For this purpose, for example a sample insertion unit as a whole may be thermally coupled with a compression refrigerating machine (for example be arranged in a cooling space of such a compression refrigerating machine), to cool the sample insertion unit. This may stabilize a fluidic sample, for example to prevent its denaturation. In other embodiments, a fluidic sample in a sample insertion unit may also be heated, for example to promote a chemical reaction of the fluidic sample in the sample insertion unit and therefore prior to the separation. A sample insertion unit of the described type may suck a fluidic sample out of a sample container and through a sample needle in a sample receiving volume (for example a sample loop), for example. This may also be accomplished by retracting a piston of a metering or dosing unit (for example a syringe pump), for example. After sucking the fluidic sample in the sample receiving volume, a sample needle may be retracted back in a sample seat. By switching a fluidic injection valve of the sample insertion unit, the sample receiving volume and thereby the fluidic sample which is received in it may be introduced in a separation path between the fluid drive and the separation unit for a subsequent sample separation in a flow of mobile phase.

According to an embodiment, alternatively or additionally, the sample handling unit thermostat unit may be configured for adjusting the temperature of a sample storing unit of the sample handling unit, wherein the sample storing unit may be configured for storing the fluidic sample, in particular before separating the fluidic sample. For example, the sample container with fluidic samples to be separated may be stored in a sample carrier, for example a microtiter plate. It is also possible to directly fill and store the fluidic sample in indentations of a sample carrier. A sample needle of a sample insertion unit may immerse in a respective sample container or directly in an indentation which is filled with fluidic sample, for example, to suck the fluidic sample which is received therein.

According to a further embodiment of the present disclosure, alternatively or additionally, the sample handling unit thermostat unit may be adapted for adjusting a temperature of a sample handling unit which is configured as fractionator. After the separation of a fluidic sample in fractions, the single fractions may flow through a flow cell to a detector and may be (for example optically) detected there. It may be advantageous to receive the fluidic sample which is separated into fractions in a sample container or the like in fractions, which may be performed in a fractionator. To protect a separated fluidic sample against a destabilization or degradation, the fractionator or a part of it may be tempered, in particular cooled, by the sample handling unit thermostat unit.

According to an embodiment, the thermal coupling unit may comprise a heat exchanger for thermally coupling the separation unit thermostat unit with the sample handling unit thermostat unit. A heat exchanger or heat transfer unit may in particular denote a device which transfers thermal energy from a medium to another medium. One of the media may origin from or be thermally coupled with the separation unit and the other one of the media may origin from or be thermally coupled with the sample handling unit. One or both of the media may be a substance stream which is passed at the heat exchanger, such that a heat exchange occurs. In the context of the operation of a heat pump, the heat exchanger may also be utilized between the separation unit thermostat unit and the sample handling unit thermostat unit.

According to an embodiment, the thermal coupling unit may comprise a, in particular unidirectional or closed, thermal fluid conduit for thermally coupling the separation unit thermostat unit with the sample handling unit thermostat unit. For example, by this thermal fluid conduit, a thermally conductive liquid or a thermally conductive gas can be conducted.

According to an embodiment, the thermal coupling unit may comprise a further, in particular unidirectional or closed, thermal fluid conduit for thermally coupling the separation unit thermostat unit with the sample handling unit thermostat unit. Also through this further thermal fluid conduit, a thermally conductive liquid or a thermally conductive gas may be conducted, for example.

According to an embodiment, one of the thermal fluid conduits may be adapted for transferring a warmer thermal coupling fluid (which may in particular be above the ambient temperature), and the other one of the thermal fluid conduits may be adapted for transferring a colder thermal coupling fluid (which may in particular be below the ambient temperature) between the separation unit thermostat unit and the sample handling unit thermostat unit. For example, when the sample handling unit thermostat unit comprises a compression refrigerating machine for cooling a sample insertion unit or a sample storing unit, the warmer waste air from the liquefier unit of the compression refrigerating machine may be conducted through one of the thermal fluid conduits to a heat exchanger which is thermally coupled with the sample separation unit thermostat unit, such that waste heat from the liquefier unit may be used for heating or additionally heating the sample separation unit. Vice versa, for example, when the sample handling unit thermostat unit comprises a compression refrigerating machine for cooling a sample insertion unit or a sample storing unit, cooler waste air from the evaporator unit of the compression refrigerating machine may be conducted through another one of the thermal fluid conduits to a heat exchanger which is thermally coupled with the sample separation unit thermostat unit, such that waste coldness from the evaporator unit may be used for cooling or additionally cooling the sample separation unit.

According to an embodiment, the thermal coupling unit may comprise at least one thermally highly conductive coupling solid body (for example at least one metal rail made of a thermally highly conductive material, such as aluminum or copper) and/or at least one heat pipe (i.e. a heat transfer unit which is in particular configured as a heat pipe, which enables a high heat flow density using evaporation heat of a substance, such that, in particular in a small cross-sectional area, large amounts of heat can be transported) for thermally coupling the separation unit thermostat unit with the sample handling unit thermostat unit. In summary, regarding the thermal coupling unit, it depends on its capability of accomplishing a heat coupling between the thermally connected thermostat units in a specific and defined manner, in particular in a controllable manner. For the type and manner of forming a corresponding thermal coupling unit, many possibilities exist. For example, it is also possible to utilize a regulatable heat pipe for forming the thermal coupling unit.

According to an embodiment, the thermal coupling unit may be adapted for thermally coupling the separation unit thermostat unit with the sample handling unit thermostat unit, such that a waste heat (i.e. heat which is transferred from the separation unit thermostat unit or the sample handling unit thermostat unit to its respective environment, which occurs in the respective adjustment of the temperature of the sample separation unit or the sample handling unit) or a waste coldness (i.e. coldness which is transferred from the separation unit thermostat unit or the sample handling unit thermostat unit to its respective environment, which occurs in the respective adjustment of the temperature of the sample separation unit or the sample handling unit) of the separation unit thermostat unit or the sample handling unit thermostat unit is used for changing the temperature, in particular for adjusting the temperature, of the other one of the separation unit thermostat unit or the sample handling unit thermostat unit. In particular, when cooling a sample handling unit by a sample handling unit thermostat unit which comprises a refrigerating machine, waste heat may occur, which, by the thermal coupling unit, can be specifically transferred to the separation unit thermostat unit for heating or additionally heating the separation unit. Thereby, the waste heat (and/or alternatively or additionally an occurring waste coldness) is not lost in a useless manner, but can be beneficially used under reducing the amount of energy which is required in total for the operation of the thermostat arrangement. Even more important, the transfer of waste heat and/or waste coldness between the thermostat units by the thermal coupling unit may enable a further operation of the sample separation device, even when one of the thermostat units fails or cannot provide a required amount of energy on its own for adjusting a temperature. Then, the other thermostat unit may provide a missing amount of energy and can maintain a correct adjustment of a temperature.

According to an embodiment, the thermal coupling unit may be adapted for thermally coupling the separation unit thermostat unit with the sample handling unit thermostat unit, such that the sample handling unit thermostat unit provides a heating power, in particular additional heating power, to the separation unit thermostat unit. This embodiment corresponds to the frequent scenario, wherein in operation of the sample separation device, the sample handling unit is cooled for protecting a temperature-sensitive fluidic sample, and the separation unit is heated for improving the reproducibility and the accuracy of a sample separation. Waste heat of the sample handling unit (in particular of a sample insertion unit) may then be transferred to the separation unit (for example at a column oven), to reduce the entire energy consumption and/or to provide a redundant heating power source for a case of a failure or a case of a high load.

According to another embodiment, the thermal coupling unit may be adapted for thermally coupling the separation unit thermostat unit with the sample handling unit thermostat unit, such that the separation unit thermostat unit provides a heating power, in particular additional heating power, to the sample handling unit thermostat unit. Such a scenario may concern an application case in which a fluidic sample shall be preheated in the sample handling unit. For example, this may be desired to trigger or to accelerate a reaction of the fluidic sample, or to cause an evaporation and thus the concentration of a fluidic sample. For example, a fluidic sample may be preheated in the sample handling unit to a temperature in a range of 30° C. to 40° C. Waste heat of a column tempering may then be supplied to a sample insertion unit or a sample storing unit.

According to yet another embodiment, the thermal coupling unit may be adapted for thermally coupling the separation unit thermostat unit with the sample handling unit thermostat unit, such that the sample handling unit thermostat unit provides a cooling power, in particular additional cooling power, to the separation unit thermostat unit. In such a procedure, a separation of a cooled fluidic sample can be supported by transferring waste coldness of the sample handling unit thermostat unit to the separation unit thermostat unit.

According to a further embodiment, the thermal coupling unit may be adapted for thermally coupling the separation unit thermostat unit with the sample handling unit thermostat unit, such that the separation unit thermostat unit provides a cooling power, in particular additional cooling power, to the sample handling unit thermostat unit.

According to an embodiment, the thermal coupling unit may be adapted for thermally coupling the separation unit thermostat unit with the sample handling unit thermostat unit, such that, in particular independently from a laboratory ambient temperature, the separation unit is adjustable to a temperature of maximum 8° C., in particular of maximum 4° C. Usually, a chromatography sample separation device is specified such that a sample cooling in the separation unit is supported down to a certain temperature which is depending on the ambient temperature. By being able to energetically support a cooling of the separation unit thermostat unit, according to an embodiment by thermal coupling with the sample handling unit thermostat unit, —independently from an ambient temperature in an application environment of the sample separation device—a tempering of the separation unit to not above 8° C. or even to not above 4° C. can be advantageously guaranteed.

According to an embodiment, the thermal coupling unit may be adapted for thermally coupling the separation unit thermostat unit with the sample handling unit thermostat unit, such that, when the separation unit thermostat unit or the sample handling unit thermostat unit fails or is overloaded, the respectively other thermostat unit overtakes the function of the failed thermostat unit in whole or in part. Due to the specific thermal couplability of the different thermostat units by the thermal coupling unit, a disturbance-free further operation of the sample separation device may be enabled, even in the case when one of the thermostat units is only operable in a restricted manner or even fails completely. In such a scenario, the thermal coupling unit may be controlled, such that the cooling energy or the heating energy which is provided by the disturbed thermostat unit in a normal operation, is delivered by the respectively other thermostat unit. In this way, almost without additional equipment, a redundant thermostat system is provided which in summary significantly improves the error-robustness of the operation of the sample separation device. In this connection, it is especially advantageous when the thermal coupling unit is configured to be controllable, such that, in case of a (for example sensorial) recognition of a disturbance or an overload of one of the thermostat units, the thermal coupling unit is controlled by a corresponding control unit, such that the disturbed or overloaded thermostat unit, by a corresponding reinforcement of a thermal coupling with another non-disturbed or not completely loaded thermostat unit, is at least temporarily supplied with a missing amount of heat or coldness by the other thermostat unit.

According to an embodiment, the separation unit thermostat unit may comprise a separation unit receiving space and a Peltier-element which is thermally coupled with the thermal coupling unit, for adjusting the temperature of the separation unit in the separation unit receiving space. In particular, the separation unit receiving space may be a column oven in which at least one chromatographic separation column is mounted as separation unit. A Peltier-element in the separation unit receiving space may be selectively controlled, to heat or to cool the at least one separation unit which is stored there. A Peltier-element therefore constitutes an especially efficient possibility for tempering the column. Alternatively, there are other possibilities for tempering the column, for example a resistance heater.

According to an embodiment, the sample handling unit thermostat unit may comprise:
a sample handling unit receiving space (which in particular may be configured as a cooling space) which is (in particular fully or partially) receiving the sample handling unit, which sample handling unit receiving space is thermally coupled with a fluid path along which a working fluid circulates;
an evaporator unit (which may constitute a cold side in operation) for evaporating the working fluid, wherein the evaporator unit is thermally coupled with the sample handling unit receiving space;
a liquefier unit (also denoted as condenser which may constitute a warm side in operation) for liquefying the working fluid which is evaporated in the evaporator unit;
a compressor unit for compressing the (in particular gaseous) working fluid which flows from the evaporator unit in the direction of the liquefier unit; and
an expansion unit (which may also be denoted as restrictor (German: Drossel)) for expanding the (in particular liquid) working fluid which flows from the liquefier unit in the direction of the evaporator unit.

Descriptively, the sample handling unit thermostat unit may also be configured as compression refrigerating machine which descriptively uses the physical effect of the evaporating enthalpy when changing the aggregation state of the working fluid from liquid to gaseous, to cool the sample handling unit and the fluidic sample which is contained therein.

Advantageously, the liquefier unit (which may constitute a warm side) and/or the evaporator unit (which may constitute a cold side) may be thermally coupled with the thermal coupling unit. In particular, the liquefier unit, in case of a thermal coupling with the separation unit thermostat unit, may provide waste heat from the compression refrigerating machine to the separation unit by the thermal coupling unit. This may correspond to a normal operation, wherein the separation unit is heated in operation for ensuring a high precision and reproducing accuracy. Alternatively, it is possible that the evaporator unit, in case of a thermal coupling with the separation unit thermostat unit, may provide coldness from the compression refrigerating machine to the separation unit by the thermal coupling unit. This may correspond to a special operation, wherein the separation unit shall be cooled, for example for special separation processes.

According to an embodiment, the thermostat arrangement may comprise a control unit for controlling the thermal coupling unit for thermally coupling the separation unit thermostat unit with the sample handling unit thermostat unit according to a pregiven or predetermined control algorithm. Alternatively or additionally, the thermal coupling unit may comprise at least one control element (which may be controllable by the control unit) for controlling a thermal coupling (in particular a thermal flow) between the separation unit thermostat unit and the sample handling unit thermostat unit. For example, the thermostat arrangement may comprise a control unit for controlling the thermal coupling unit, such that, by controlling, the sample handling unit thermostat unit and the separation unit thermostat unit are selectively coupled with each other or are thermally decoupled from each other. Such a control logic is descriptively “digital”, i.e., selectively enables the adjustment “thermally coupled” or “thermally decoupled”. However, it is also possible to perform controlling, such that the sample handling unit thermostat unit and the separation unit thermostat unit are selectively thermally coupled with each other to a pregivable or predeterminable extent. In particular, it may be controlled in a stepless or stepwise manner which amount of heat and/or amount of coldness is transferred between the gradually thermally coupled thermostat units. Such a control unit may in particular comprise a processor which pre-gives a corresponding control. A thermally conductive path between the thermostat units may be correspondingly influenced by a control element which may comprise a flap, a valve, a ventilator, and/or a pump, for example. For example, a valve may be opened or closed, to enable or to disable a thermal coupling between the thermostat units. For example, a pump may be gradually controlled, to adjust the flow rate of a thermal coupling fluid through a thermal fluid conduit, whereby an extent of a heat coupling between the thermostat units can be adjusted in a stepless manner.

In particular, the control unit may be adapted for controlling the thermal coupling unit for thermally coupling the separation unit thermostat unit with the sample handling unit thermostat unit according to an efficiency regulating logic. For example, the system may be adjusted to a target temperature or to such a temperature, where the respective thermostat operates in the most efficient manner.

According to an embodiment, the thermal coupling unit may be adapted for constantly or for dynamically thermally coupling or decoupling the separation unit thermostat unit and the sample handling unit thermostat unit. In case of a constant coupling, the thermal coupling unit may permanently couple the thermostat units. In case of a dynamic coupling, a coupling state and/or a decoupling state may be changed over time and/or an extent of a coupling between the thermostat units may be changed depending on time, namely in a controlled or regulated manner.

According to an embodiment, the control unit may be adapted for controlling the thermal coupling unit for adjusting an operation point, in particular to a target operation point, of the separation unit thermostat unit and/or of the sample handling unit thermostat unit. By using and transferring waste heat and/or waste coldness, in particular of the sample handling unit thermostat unit, (in particular when using a Peltier-element for heating or cooling in the separation unit thermostat unit) an optimal operation point, in particular of the separation unit thermostat unit, may be adjusted.

Advantageously, for thermally coupling the separation unit thermostat unit with the sample handling unit thermostat unit may be accomplished by transferring a thermal coupling fluid which is different from the mobile phase and the fluidic sample, in particular through at least one thermal fluid conduit. The thermal coupling fluid may be a liquid (in particular water) or a gas (in particular air).

According to an embodiment, the separation unit may be configured as a chromatographic separation unit, in particular as a chromatography separation column. In a chromatographic separation, the chromatography separation column may be provided with an adsorption medium. At this, the fluidic sample may be retained and may be released only subsequently in fractions with sufficient eluent (isocratically) or in presence of a specific solvent composition (gradient), whereby the separation of the sample into its fractions is accomplished.

The sample separation device may be a microfluidic measuring device, a life science device, a liquid chromatography (LC) device, an HPLC (high-performance liquid chromatography) device, a UHPLC (ultra-high-performance liquid chromatography) device, an SFC (supercritical fluid chromatography) device, a gas chromatography (GC) device, an electric chromatography device, and/or a gel electrophoresis device. However, many other applications are possible.

For example, the fluid drive may be adapted for conveying the mobile phase with a high pressure, for example some 100 bar up to 1000 bar and more, through the system.

The sample separation device may comprise a sample injector for introducing the sample in the fluidic separation path. Such a sample injector may comprise an injection needle which is couplable with a seat in a corresponding liquid path, wherein the needle can be extended out of this seat, to receive the sample, wherein after reinserting the needle into the seat, the sample is located in a fluid path which, for example by switching a valve, can be connected with the separation path of the system, which leads to introducing the sample in the fluidic separation path.

The sample separation device may comprise a fraction collector for collecting the separated components. Such a fraction collector may lead the different components, for example in different liquid containers. However, the analyzed sample can also be supplied to a waste container.

The sample separation device may comprise a detector for a detection of the separated components. Such a detector may generate a signal which can be observed and/or recorded, and which is indicative for the presence and the amount of the sample components in the fluid which flows through the system.

### BRIEF DESCRIPTION OF THE DRAWINGS

Other objects and many of the accompanying advantages of embodiments of the present disclosure will become easy to recognize and better to understand under reference to the following detailed description of embodiments in connection with the accompanying drawings. Features which are substantially or functionally same or similar, are provided with the same reference signs.

FIG. 1 shows an HPLC system as sample separation device according to an exemplary embodiment of the present disclosure.

FIG. 2 shows a thermostat arrangement according to an exemplary embodiment of the present disclosure.

FIG. 3 shows a thermostat arrangement according to another exemplary embodiment of the present disclosure.

FIG. 4 shows a sample insertion unit which may be implemented in a thermally coupled manner in a sample separation device and/or in a thermostat arrangement according to an exemplary embodiment of the present disclosure.

FIG. 5 shows a thermostat arrangement according to yet another exemplary embodiment of the present disclosure.

The illustrations in the drawings are schematic.

### DETAILED DESCRIPTION

Before referring to the drawing figures and describing exemplary embodiments, some basic considerations shall be summarized, based on which exemplary embodiments of the present disclosure have been derived.

Conventionally, injector thermostatization and column thermostatization are two thermal regions in a sample separation device, in particular in an HPLC, which are independent and not coupled with each other. This means that energy has to be separately provided for both function cycles. The resulting waste heat is supplied to the environment as loss heat.

According to an embodiment of the present disclosure, a thermostat arrangement for a (in particular liquid chromatography) sample separation device is provided. It encompasses a separation unit thermostat unit by which the temperature of a separation unit (in particular of a chromatographic separation column) for separating the fluidic sample in a mobile phase can be adjusted. Moreover, a sample handling unit thermostat unit for adjusting the temperature of a sample handling unit is provided which accomplishes the tempering of a sample insertion unit for inserting the fluidic sample in a separation path, for example. Advantageously, a (controllable or regulatable) thermal coupling unit is provided, which can thermally couple the separation unit thermostat unit with the sample handling unit thermostat unit, such that a heat transfer (for example of waste heat) between the thermostat units is enabled. Thereby, the waste heat or a waste coldness of one of the thermostat units can be made usable in the respectively other thermostat unit. This reduces not only the ecological fingerprint of the sample separation device but enables in an advantageous manner to implement a redundant system of thermostats in the sample separation device, which can mutually support or replace each other. Thus, in a failure case, one of the thermostat units can replace the other one. In case of a temporarily unusually high heat- or coldness demand of a thermostat unit, the other one can support it by the provision of a heat- or a coldness portion.

In particular, according to an embodiment of the present disclosure, a heat exchange between an injector thermostat and a column thermostat may be enabled. Therefore, the thermal cycles of the thermostats, in contrast to conventional approaches, are not configured to be thermally independent from each other, but are thermally coupled with each other. This has advantages: frequently, the injector cools while the column oven heats, such that the waste heat of the injector thermostat may be used for the column thermostat. Moreover, the thermal coupling or couplability of both thermostats of the sample separation device leads to a redundancy for the cooling and/or the heating system, in particular of the injector, for example for providing an emergency system for securing valuable samples in a failure case of a thermostat. Vice versa, according to exemplary embodiments, it is enabled to co-use the thermal power of an injector-cooling also for the column-cooling which otherwise is merely accomplished by a Peltier-element. In particular, according to exemplary embodiments of the present disclosure, a waste heat- and/or waste coldness-recycling is enabled, wherein in particular a waste heat or waste coldness from the injector thermostat can be used for a support of the column thermostat (or vice versa).

In particular, the waste heat of a sample insertion unit thermostat unit (in particular of a sampler thermostat) may be utilized for the support of the heating function of a separation unit thermostat unit (in particular of a column thermostat). By supplying the waste heat, a required temperature rise, which the separation unit thermostat unit has to perform, can be advantageously reduced. Thereby, the energy effort for the operation of the separation unit thermostat unit may be reduced. According to an exemplary embodiment, it is also enabled to utilize a cooling power of a sample handling unit thermostat unit (in particular of a sampler thermostat) for cooling the separation unit (in particular a chromatography separation column). By using the waste heat and/or the waste coldness of the sampler thermostat, when using a Peltier-element, in the column thermostat, the optimal operation point for the Peltier-element can always be adjusted. Thereby, the efficiency of the Peltier-element is increased.

According to an embodiment, the waste heat of the sampler thermostat may be utilized for the support of the heating power of the column thermostat and is thereby not dissipated to the environment in an unused manner. The generation of the coldness may be used to improve the cooling power of the column thermostat. By using the cooling power of the sampler thermostat, lower temperatures in the column oven can be achieved. While conventionally a temperature difference to the ambient temperature is specified, an always achievable temperature of maximum 4° C. can thereby be specified. In addition, a high efficiency of the entire cooling power may be realized, since the cooling power of the sampler thermostat can reinforce the cooling function of the column oven or vice versa. Thereby, the protection of thermally unstable analytes (i.e. temperature-sensitive fluidic samples) can be improved. Alternatively or additionally, additional functions, such as tempering the column to 4° C. independently from an ambient temperature, may be implemented. By a combination of a, for example compressor-generated, tempering of a sample handling unit and a tempering of a separation unit which is generated by a Peltier-element, both tempering systems (in particular cooling systems) can be synergistically combined with each other. By the intelligent use of occurring waste heat and/or waste coldness, the thermal efficiency of the entire system can be increased. In particular, an improvement of the energy efficiency of the system by the use of the waste heat may be achieved. Alternatively or additionally, also an extension of the specifications of thermostat units of a sample separation device can be performed.

According to exemplary embodiments of the present disclosure, the supply of heat and coldness may be constant or also regulated. For example, this may be achieved by flaps, valves, ventilators, or pumps, and/or by other elements for a generation and control of fluid streams. These may be controlled to achieve a certain temperature, for example. Besides the use of liquid and air as energy carriers, also further energy carriers may be used.

The use of a Peltier-element in a separation unit thermostat unit is advantageous, but not mandatory.

FIG. 1 shows the basic structure of a HPLC-system as example for a separation device 10, as it can be used for the liquid chromatography, for example. A fluid pump as fluid drive 20 which is supplied with solvents from a supply unit 25, drives a mobile phase through a separation unit 30 (for example a chromatographic column) which contains a stationary phase. A degas ser 27 may degas the solvents before these are supplied to the fluid drive 20. A sample insertion unit 40 with a switching valve or a fluid valve 95 is arranged between the fluid drive 20 and the separation unit 30, to introduce a sample liquid in the fluidic separation path. The stationary phase of the separation unit 30 is provided for separating components of the sample. A detector 50, for example comprising a flow cell, detects the separated components of the sample. A fractionator 60 may be provided to dispense separated components of the sample in containers which are provided for this purpose. Liquids which are not required anymore may be dispensed in a waste container (not shown).

A control unit 70 controls the single components 20, 25, 27, 30, 40, 50, 60, 95 of the sample separation device 10.

FIG. 1 also shows a thermostat arrangement 100 of the sample separation device 10 which comprises a separation unit thermostat unit 102 for adjusting the temperature of the separation unit 30 for separating the fluidic sample in a mobile phase. Descriptively, the separation unit thermostat unit 102 may comprise a column oven in which the separation unit 30 which is configured as a chromatography separation column may be mounted in a thermally coupled manner, in particular to be heated there. Heating conditions the separation unit 30, such that separation runs can be performed in a reproducible and precise manner. For other applications examples (for example for certain separation tasks), it may also be possible to cool the separation unit 30.

Moreover, the thermostat arrangement 100 comprises a sample handling unit thermostat unit 104 for adjusting the temperature of a sample handling unit 40, 42 for handling the fluidic sample. The sample handling unit 40, 42 which is used for handling the fluidic sample encompasses two separate function blocks, namely the already mentioned sample insertion unit 40 and a sample storing unit 42.

The sample insertion unit 40 functions for receiving and subsequently introducing a fluidic sample in a separation path 111 between the fluid drive 20 and the separation unit 30.

The sample storing unit 42 serves for temporarily storing the fluidic sample before it is received in the sample insertion unit 40. As schematically illustrated in FIG. 1, the sample storing unit 42 may comprise a sample carrier with a plurality of receiving openings, each of which serving for receiving a respective fluidic sample. This reception may either be performed directly in a respective receiving opening, or by receiving a sample container 113 in a respective receiving unit.

Corresponding to the, according to FIG. 1 two-part, configuration of the sample handling unit 40, 42, according to FIG. 1, also the sample handling unit thermostat unit 104 encompasses two separate function blocks. On the one hand, the sample handling unit thermostat unit 104 encompasses a thermostat 104A which is assigned to the sample insertion unit 40, which can adjust the temperature of the sample insertion unit 40 and can cool the latter, in particular for a protection of the sample. On the other hand, the sample handling unit thermostat unit 104 encompasses a further thermostat 104B which is assigned to the sample storing unit 42, which can adjust the temperature of the sample storing unit 42 and can cool the latter, in particular for a protection of the sample. In other application examples, it may be desirable to heat (instead of cool) the sample in the thermostat 104A and/or in the thermostat 104B, for example to evaporate a solvent and/or to trigger a chemical reaction.

FIG. 1 further shows a thermal coupling unit 106 for thermally coupling the separation unit thermostat unit 102 with the thermostat 104A and/or with the thermostat 104B of the sample handling unit thermostat unit 104. As shown in FIG. 1, between the single thermostats according to the reference signs 104A, 104B, 102, control elements 118 may be provided. The control elements 118 may be controlled, for example by the control unit 70 which is illustrated in FIG. 1, to adjust a thermal coupling state between the thermostats according to the reference signs 104A, 104B, 102, which are coupled by a respective control element 118. The thermal coupling state may selectively be thermally coupling two respective thermostats 104A, 104B, 102, thermally decoupling two respective thermostats 104A, 104B, 102, and/or thermally coupling two respective thermostats 104A, 104B, 102 according to a pregivable or predeterminable and steplessly adjustable degree of coupling. Examples for suitable control elements 118 are a flap which can be fully or partially opened or closed, a valve which can be fully or partially opened or closed, a ventilator with an adjustable degree of ventilation for promoting the heat exchange, and/or a pump for conveying a heat exchange fluid. By the control elements 118, also controlling a thermal flow between the separation unit thermostat unit 102 and the thermostats 104A and/or 104B of the sample handling unit thermostat unit 104 is enabled.

The control unit 70 which is shown in FIG. 1 may thus be adapted for controlling the control elements 118 of the thermal coupling unit 106 for thermally coupling the separation unit thermostat unit 102 with the sample handling unit thermostat unit 104 according to a pregiven or predetermined control algorithm. In particular, the control unit 70 may be adapted for controlling the thermal coupling unit 106 for adjusting a target operation point of the separation unit thermostat unit 102 and/or of the sample handling unit thermostat unit 104.

The thermal coupling unit 106 may comprise an arbitrary physical entity 106′ which may cause a specific and defined heat flow between the separation unit thermostat unit 102 and the thermostats 104A and/or 104B of the sample handling unit thermostat unit 104. For example, the thermal coupling unit 106 may transfer a thermal coupling fluid between the separation unit thermostat unit 102 and the sample handling unit thermostat unit 104, to transfer heat or coldness. Alternatively or additionally, it is also possible that the thermal coupling unit 106 comprises one or more thermally highly conductive coupling solid bodies (such as with a heat conductivity of at least 50 W/mK, for example a copper rail) and/or one or more heat pipes for thermally coupling the separation unit thermostat unit 102 with the sample handling unit thermostat unit 104.

By thermally coupling the separation unit thermostat unit 102 and at least one of the thermostats 104A and/or 104B of the sample handling unit thermostat unit 104, waste heat and/or waste coldness can be transferred between the thermostat units 102, 104, and can therefore be used sensibly. For example, waste heat of the thermostats 104A and/or 104B of the sample handling unit thermostat unit 104 may be supplied to the separation unit thermostat unit 102, which can be co-used for heating the separation unit 30. In case of a disturbance or failure of the separation unit thermostat unit 102 or of the sample handling unit thermostat unit 104, the respectively other thermostat unit may at least temporarily and/or at least partially overtake the function of the disturbed or failed thermostat unit, whereby a redundant thermal security system is provided. Thereby, even when a thermostat unit fails, a thermally stable fluidic sample can be protected against thermal destruction, for example.

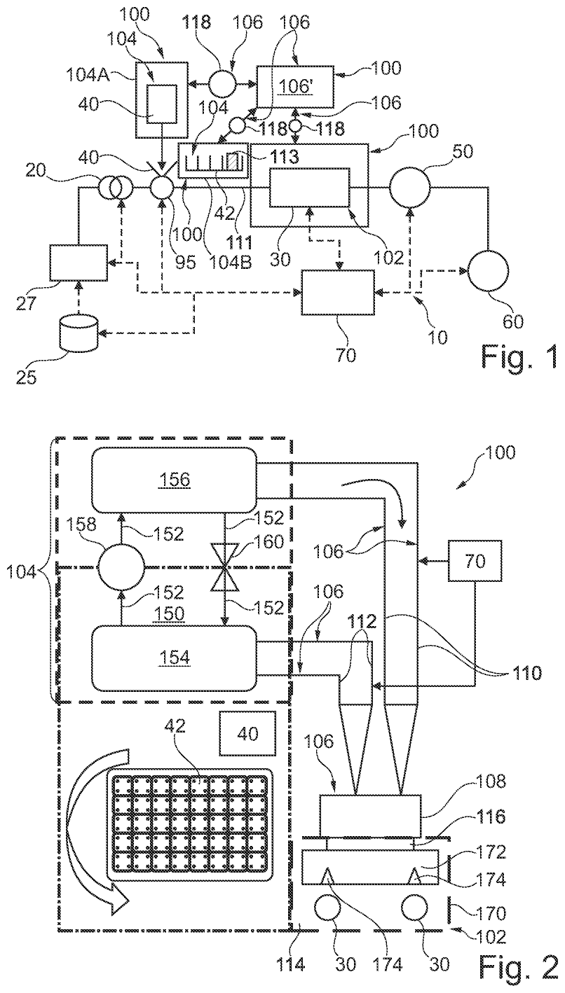

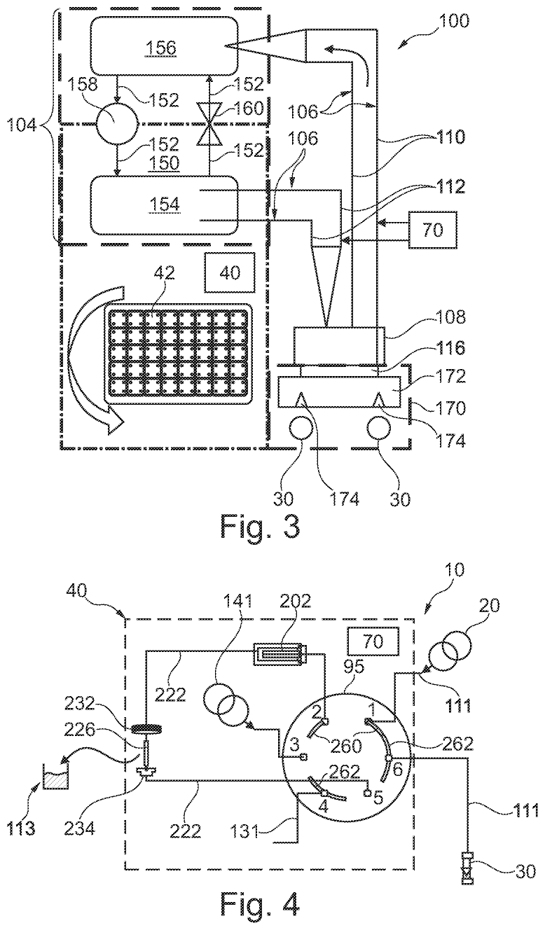

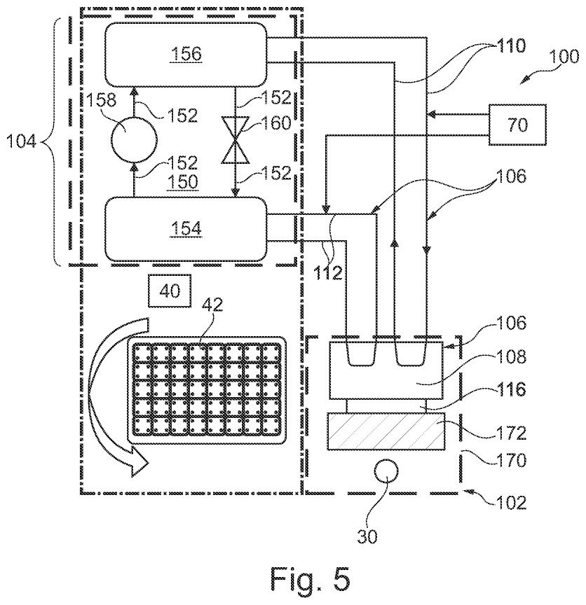

FIG. 2 shows a thermostat arrangement 100 for a sample separation device 10 (see FIG. 1) according to an embodiment of the present disclosure. Descriptively, FIG. 2 shows a sample insertion unit 40 with a thermostatization primarily by the sample handling unit thermostat unit 104. Furthermore, FIG. 2 shows separation units 30 in form of two chromatographic separation columns with the thermostatization primarily by the separation unit thermostat unit 102. Moreover, a thermal connection between the thermostat units 102, 104 is illustrated, which is formed by a thermal coupling unit 106. The thermal coupling unit 106 may be actively controlled by a control unit 70, as illustrated in FIG. 2 (and correspondingly in FIG. 3 and in FIG. 5) with the reference sign 70. Alternatively, the thermal coupling unit 106 may be purely passive, i.e., may operate without an active control. The thermostat arrangement 100 which is illustrated in FIG. 2 may be used in a sample separation device 10 for separating a fluidic sample, in particular in an HPLC.

The sample handling unit thermostat unit 104 functions for adjusting the temperature of a respective sample handling unit 40, 42 for handling a fluidic sample to be separated. In more detail, the sample handling unit thermostat unit 104 serves for adjusting the temperature of the sample handling units 40, 42 for handling the fluidic sample before inserting the fluidic sample in a fluidic path between a fluid drive 20 (not shown in FIG. 2, see FIG. 1) and the respective separation unit 30. As in FIG. 1, the sample handling unit thermostat unit 104 may be adapted for adjusting the temperature of a sample insertion unit 40 of the sample handling units 40, 42, wherein the sample insertion unit 40 is adapted for introducing the fluidic sample in a fluidic path between the fluid drive 20 and the separation unit 30. Furthermore, the sample handling unit thermostat unit 104 may be adapted for adjusting the temperature of a sample storing unit 42 of the sample handling unit 40, 42, wherein the sample storing unit 42 is adapted for storing the fluidic sample before separating the fluidic sample.

In more detail, as illustrated in FIG. 2, the sample handling unit thermostat unit 104 comprises a sample handling unit receiving space 150 which is receiving the respective sample handling unit 40, 42 (i.e., the sample insertion unit 40 and/or the sample storing unit 42). The receiving space 150 may be thermally coupled with a fluid path 152, along which a working fluid circulates. An evaporator unit 154 serves for evaporating the working fluid and is thermally coupled with the sample handling unit receiving space 150. A liquefier unit 156, which is also denoted as condenser, functions for liquefying or condensing the working fluid which is evaporated in the evaporator unit 154. Moreover, a compressor unit 158 is provided which serves for densifying the working fluid which flows or streams from the evaporator unit 154 in the direction of the liquefier unit 156. Furthermore, an expansion unit 160 for expanding the working fluid is provided, which flows from the liquefier unit 156 in the direction of the evaporator unit 154. As described in more detail below, the liquefier unit 156 which forms a warm side during the operation, for example, and/or the evaporator unit 154 which forms a cold side during the operation, for example, may be thermally coupled with the thermal coupling unit 106. The described sample handling unit thermostat unit 104 may therefore comprise a compression refrigerating machine by which the fluidic sample in the respective sample handling unit 40, 42 can be cooled. However, in other embodiments, the sample handling unit thermostat unit 104 may also be adapted for heating a fluidic sample in the respective sample handling unit 40, 42.

The separation unit thermostat unit 102 serves for adjusting the temperature of the separation units 30 for separating a respective fluidic sample to be separated in a mobile phase which is configured as a solvent composition. According to FIG. 2, the separation unit thermostat unit 102 comprises a tempering chamber 170 (in particular a column oven). A Peltier-element 116 (or another heating- and/or cooling element) is attached at a separation unit heat exchanger 172 in the interior of the tempering chamber 170. According to FIG. 2, at the separation unit heat exchanger 172, optional preheating units 174 are attached which are also denoted as preheaters. The mobile phase flows through the preheating units 174, which can be preheated at the preheating units 174, before the preheated mobile phase subsequently flows through the separation units 30 which are here configured as a chromatographic separation columns. The separation units 30 are also mounted in the tempering chamber 170 and thermally conductively coupled with the Peltier-element 116 and the separation unit heat exchanger 172, such that the separation units 30 can be heated or cooled with thermal energy of the Peltier-element 116. Therefore, according to FIG. 2, the separation unit thermostat unit 102 comprises a separation unit receiving space 114 and the Peltier-element 116 which is also thermally coupled with the thermal coupling unit 106 which is described in more detail below, for adjusting the temperature of the separation units 30 in the separation unit receiving space 114.

The thermal coupling unit 106 serves for thermally coupling the separation unit thermostat unit 102 with the sample handling unit thermostat unit 104, in the illustrated embodiment to use waste heat (or alternatively waste coldness) of the sample handling unit thermostat unit 104 at least partially for the operation of the separation unit thermostat unit (wherein the functions of the separation unit thermostat unit 102 and of the sample handling unit thermostat unit 104 may also be vice versa). FIG. 2 illustrates, that the thermal coupling unit 106 comprises a heat exchanger 108 for thermally coupling the separation unit thermostat unit 102 with the sample handling unit thermostat unit 104.

According to FIG. 2, the heat exchanger 108 is attached at an outer side of the tempering chamber 170 of the separation unit thermostat unit 102. In more detail, the heat exchanger 108 is attached at the above-described Peltier-element 116, by which the interior of the tempering chamber 170 and therefore also the separation units 30 which are configured as a chromatographic separation columns which are mounted there, are heated (or alternatively cooled) in the illustrated embodiment. Thus, the Peltier-element 116 may be thermally coupled with both heat exchangers 108, 172, i.e., with the heat exchanger 172 inside of the column oven of the separation unit thermostat unit 102 and with the heat exchanger 108 outside of the column oven of the thermal coupling unit 106.

FIG. 2 further shows that the thermal coupling unit 106 comprises a thermal fluid conduit 110 for thermally coupling the separation unit thermostat unit 102 with the (here warm) liquefier unit 156 of the sample handling unit thermostat unit 104. For example, a hot gas (for example hot air) may stream through the thermal fluid conduit 110, to thereby heat the heat exchanger 108 which is thermally coupled with it. To actively promote this gas flow, also a ventilator may be used which is not illustrated in FIG. 2. Therefore, in the illustrated embodiment, the thermal fluid conduit 110 serves for transferring a warm thermal coupling fluid from the sample handling unit thermostat unit 104 to the heat exchanger 108 of the thermal coupling unit 106 which is thereby heated, and therefore heat is supplied to the separation unit thermostat unit 102 (see arrow). Thereby, waste heat of the sample handling unit thermostat unit 104 may be used for heating the separation unit thermostat unit 102.

Moreover, FIG. 2 shows that the thermal coupling unit 106 alternatively or additionally may comprise a further thermal fluid conduit 112 for thermally coupling the separation unit thermostat unit 102 with the (here cold) evaporator unit 154 of the sample handling unit thermostat unit 104. For example, a cold gas (for example cold air) may stream through the further thermal fluid conduit 112, which may be promoted by a not illustrated ventilator. However, in the described application case, the waste heat of the sample handling unit thermostat unit 104 shall be transferred to the separation unit thermostat unit 102, such that the further thermal fluid conduit 112 (for example by the control unit 70 which may close a not illustrated control element 118 in the further thermal fluid conduit 112, for example) can be closed and thus be deactivated. However, if the waste heat of the sample handling unit thermostat unit 104 shall be transferred to the separation unit thermostat unit 102 in a regulated manner, in case of an excessive heat transfer, the further thermal fluid conduit 112 may be at least temporarily and/or at least partially opened, to compensate the excessive heat by coldness which is supplied by the further thermal fluid conduit 112.

Generally, the thermal coupling unit 106 may be adapted for thermally coupling the separation unit thermostat unit 102 with the sample handling unit thermostat unit 104, such that a waste heat or a waste coldness of the separation unit thermostat unit 102 or of the sample handling unit thermostat unit 104 can be used for adjusting the temperature of the other one of the separation unit thermostat unit 102 or the sample handling unit thermostat unit 104.

According to FIG. 2, the thermal coupling unit 106 may be adapted for thermally coupling the separation unit thermostat unit 102 with the sample handling unit thermostat unit 104, such that the sample handling unit thermostat unit 104 provides a heating power to the separation unit thermostat unit 102. In particular, this may be additional heating power in addition to the heating power which is provided by the Peltier-element 116.

Especially advantageously, the thermal coupling unit 106 may be adapted for thermally coupling the separation unit thermostat unit 102 with the sample handling unit thermostat unit 104, such that, when for example the separation unit thermostat unit 102 fails (for example because the Peltier-element 116 is defect), the sample handling unit thermostat unit 104 overtakes the heating function of the separation unit thermostat unit 102 (for example until the defect Peltier-element 116 is repaired or exchanged). By this redundant heating function, the sample separation device 10 can be operated in an especially error-robust manner.

The illustration according to FIG. 2 thus corresponds to an application case in which the sample handling unit thermostat unit 104 cools the sample handling unit(s) 40 and/or 42. The waste heat of the sample handling unit thermostat unit 104 is used for preheating the exterior heat exchanger 108 which is attached at the separation unit thermostat unit 102 and therefore supplies thermal energy to it.

FIG. 3 shows a thermostat arrangement 100 according to another exemplary embodiment of the present disclosure.

The illustration according to FIG. 3 differs from the illustration according to FIG. 2 substantially in that FIG. 3 corresponds to an application case wherein the separation unit thermostat unit 102 cools the separation units 30. Occurring waste heat of the separation unit thermostat unit 102 is used for preheating the exterior heat exchanger 106 for the sample handling unit thermostat unit 104 which functions for heating the sample handling unit(s) 40 and/or 42, according to FIG. 3. According to FIG. 3, heating the sample handling unit(s) 40 and/or 42 is achieved by the arrangement of the evaporator unit 154, the liquefier unit 156, the compressor unit 158, and the expansion unit 160 now being passed by the working fluid 152 in an inverse direction compared to FIG. 2. Therefore, according to the operation of FIG. 3, now the evaporator unit 154 forms the warm side, and the liquefier unit 156 forms the cold side.

FIG. 3 further shows that the thermal fluid conduit 110 comprises for thermally coupling the separation unit thermostat unit 102 with the (here cold) liquefier unit 156 of the sample handling unit thermostat unit 104. For example, a hot gas (for example hot air) from the heat exchanger 108 may stream through the thermal fluid conduit 110, to thereby heat the liquefier unit 156 which is thermally coupled with it (see arrow). Thus, the thermal fluid conduit 110 serves in the illustrated embodiment for transferring a warm thermal coupling fluid from the heat exchanger 108 of the thermal coupling unit 106 to the sample handling unit thermostat unit 104 which is thereby heated. Thereby, the waste heat of the separation unit thermostat unit 102 may be used for heating the sample handling unit thermostat unit 104.

FIG. 3 moreover shows that the further thermal fluid conduit 112 can be adapted for thermally coupling the separation unit thermostat unit 102 with the (here warm) evaporator unit 154 of the sample handling unit thermostat unit 104. For example, a cold gas (for example cold air) may stream through the further thermal fluid conduit 112. However, in the described application case, the waste heat of the separation unit thermostat unit 102 shall be transferred to the sample handling unit thermostat unit 104, such that the further thermal fluid conduit 112 can be closed and thereby deactivated (for example by the control unit 70). However, if the waste heat of the separation unit thermostat unit 102 shall be transferred in a regulated manner to the sample handling unit thermostat unit 104 (or a thermal transfer in the reverse direction shall be accomplished), in case of an excessive heat transfer, the further thermal fluid conduit 112 can be at least temporarily and/or at least partially opened, to compensate the excessive heat by coldness which is supplied by the further thermal fluid conduit 112.

FIG. 4 shows a structure of a sample insertion unit 40 which may be implemented in a thermally coupled manner in a thermostat arrangement 100 (for example according to FIG. 1 to FIG. 3 or FIG. 5) according to an exemplary embodiment of the present disclosure.

A fluid valve 95 which is configured as an injection valve is mounted in a liquid chromatography sample separation device 10 for separating a fluidic sample. As can be recognized in FIG. 4, the sample separation device 10 comprises a fluid drive 20 which is configured as a high-pressure pump for driving a mobile phase (i.e., a solvent or a solvent composition) and a fluidic sample which is to be injected in the mobile phase by the injector and/or the sample insertion unit 40. The fluidic sample shall be separated in its fractions by the sample separation device 10. The actual separation is performed by the sample separation unit 30 which is configured as a chromatography separation column after the injection of the fluidic sample in the mobile phase.

Here, the fluid valve 95 of the injector 40 which is illustrated in FIG. 4 serves for injecting the fluidic sample in the mobile phase in a separation path 111 between the fluid drive 20 and the sample separation unit 30. For this purpose, the sample insertion unit 40 comprises a sample reception volume 232 which is configured as a sample loop, for example, for receiving a pregivable or predeterminable volume of the fluidic sample. Furthermore, the sample insertion unit 40 which is illustrated in FIG. 4 contains a metering or dosing unit 202 which is for example configured as a syringe pump with a movable piston, for metering or dosing a fluidic sample which is to be received in the sample reception volume 232. Thus, the metering or dosing unit 202 primarily serves for metering or dosing a fluidic sample which is to be received in the sample reception volume 232, but may also be operated for compressing the fluid in the injector path 222. A waste conduit 131 serves for draining the fluid which is not required anymore, for example a rinsing fluid, the mobile phase which is not required anymore, or the fluidic sample which is not required anymore.

Moreover, the sample insertion unit 40 has a displaceable needle 226 which is received in a needle seat 234 for fluid-tightly receiving the needle 226 in a fluid-tight manner according to FIG. 4. Moreover, the needle 226 can also be extended out of the needle seat 234 and can be introduced in a sample container 113 as a sample source with the fluidic sample, to subsequently suck the fluidic sample out of the sample container 113 by retracting the piston of the metering or dosing unit 202 through the needle 226 in the sample reception volume 232.

The fluid valve 95 which is configured as a rotor valve in the illustrated embodiment has stationary ports or fluid connections which are denoted with 1 to 6, a part of them being connected with stationary grooves 260. Opposing to these stationary ports 1 to 6 and/or stationary grooves 260, rotatable grooves 262 are provided, such that different fluid connection paths can be adjusted.

According to FIG. 4, an additional fluid drive 141 (for example configured as a rinsing pump) is provided.

FIG. 5 shows a thermostat arrangement 100 according to yet another exemplary embodiment of the present disclosure.

In the embodiment according to FIG. 5, the heat exchanger 108 of the thermal coupling unit 106 is spatially arranged in the interior of the tempering chamber 170. Moreover, according to FIG. 1, only one separation unit 30 is provided.

A further difference of the embodiment according to FIG. 5, which however may also be implemented according to FIG. 2 or FIG. 3, consists in the thermal fluid conduits 110, 112 according to FIG. 5 comprising capillaries or the like through which a liquid flows, and which may be configured as closed fluid conduits. Through the thermal fluid conduit 110, a hot liquid may flow (whereas through the further thermal fluid conduit 112, a cold liquid may flow and/or which may be deactivated during the transfer of waste heat from the sample handling unit thermostat unit 104 to the separation unit thermostat unit 102, or which may only be used for regulating purposes). According to FIG. 5, the thermal fluid conduit 110 extends between the liquefier unit 156 and the heat exchanger 108. According to FIG. 5, the further thermal fluid conduit 112 extends between the evaporator unit 154 and the heat exchanger 108. The respective fluid conduit 110, 112 descriptively forms a cycle.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the control unit 70 schematically depicted in FIGS. 1-5. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the control unit 70 schematically depicted in FIGS. 1-5), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It should be noted that the term “comprise” does not exclude other elements, and that the term “a” does not exclude a plurality. Also, elements which are described in connection with different embodiments, may be combined. It should further be noted that reference signs in the claims are not to be construed as limiting the scope of protection of the claims.

What is claimed is:

1. A thermostat arrangement for a sample separation device for separating a fluidic sample, the thermostat arrangement comprising:
a separation unit thermostat unit configured to adjust the temperature of a separation unit for separating the fluidic sample in a mobile phase;
a sample handling unit thermostat unit configured to adjust the temperature of a sample handling unit for handling the fluidic sample; and
a thermal coupling unit configured to thermally couple the separation unit thermostat unit with the sample handling unit thermostat unit.

2. The thermostat arrangement according to claim 1, wherein the sample handling unit thermostat unit is configured to adjust the temperature of the sample handling unit for handling the fluidic sample prior to inserting the fluidic sample in a fluidic path between a fluid drive and the separation unit.

3. The thermostat arrangement according to claim 1, wherein the sample handling unit thermostat unit is configured to adjust the temperature of a sample insertion unit of the sample handling unit, wherein the sample insertion unit is configured to insert the fluidic sample in a fluidic path between a fluid drive and the separation unit.

4. The thermostat arrangement according to claim 1, wherein the sample handling unit thermostat unit is configured to adjust the temperature of a sample storing unit of the sample handling unit, wherein the sample storing unit is configured to store the fluidic sample prior to a separation of the fluidic sample.

5. The thermostat arrangement according to claim 1, wherein the thermal coupling unit comprises a heat exchanger configured to thermally couple the separation unit thermostat unit with the sample handling unit thermostat unit.

6. The thermostat arrangement according to claim 1, wherein the thermal coupling unit comprises a unidirectional or closed thermal fluid conduit configured to thermally couple the separation unit thermostat unit with the sample handling unit thermostat unit.

7. The thermostat arrangement according to claim 6, wherein the thermal coupling unit comprises a further unidirectional or closed thermal fluid conduit configured to thermally couple the separation unit thermostat unit with the sample handling unit thermostat unit.

8. The thermostat arrangement according to claim 6, wherein one of the thermal fluid conduits is configured to transfer a warmer thermal coupling fluid and the other one of the thermal fluid conduits is configured to transfer a colder thermal coupling fluid between the separation unit thermostat unit and the sample handling unit thermostat unit.

9. The thermostat arrangement according to claim 1, wherein the thermal coupling unit comprises at least one thermally highly conductive coupling solid body and/or at least one heat pipe configured to thermally couple the separation unit thermostat unit with the sample handling unit thermostat unit.

10. The thermostat arrangement according to claim 1, wherein the thermal coupling unit is configured to thermally couple the separation unit thermostat unit with the sample handling unit thermostat unit, such that a waste heat or a waste coldness of the separation unit thermostat unit or of the sample handling unit thermostat unit is used for changing the temperature, of the other one of the separation unit thermostat unit or the sample handling unit thermostat unit.

11. The thermostat arrangement according to claim 1, wherein the thermal coupling unit is configured to thermally couple the separation unit thermostat unit with the sample handling unit thermostat unit, such that the sample handling unit thermostat unit provides a heating power to the separation unit thermostat unit.

12. The thermostat arrangement according to claim 1, wherein the thermal coupling unit is configured to thermally couple the separation unit thermostat unit with the sample handling unit thermostat unit, such that the separation unit thermostat unit provides a heating power to the sample handling unit thermostat unit.

13. The thermostat arrangement according to claim 1, comprising at least one of the following features:
wherein the thermal coupling unit is configured to thermally couple the separation unit thermostat unit with the sample handling unit thermostat unit, such that the separation unit thermostat unit provides a cooling power to the sample handling unit thermostat unit;
wherein the thermal coupling unit is configured to thermally couple the separation unit thermostat unit with the sample handling unit thermostat unit, such that the sample handling unit thermostat unit provides a cooling power to the separation unit thermostat unit;
wherein the thermal coupling unit is configured to thermally couple the separation unit thermostat unit with the sample handling unit thermostat unit, such that the separation unit is adjustable to a temperature of maximum 8° C.;
wherein the thermal coupling unit is configured to thermally couple the separation unit thermostat unit with the sample handling unit thermostat unit, such that the separation unit is adjustable to a temperature of maximum 4° C.;
wherein the thermal coupling unit is configured to thermally couple the separation unit thermostat unit with the sample handling unit thermostat unit, such that, when the separation unit thermostat unit or the sample handling unit thermostat unit fails or is overloaded, the respective other thermostat unit takes over the function of the failed thermostat unit in whole or in part;
wherein the separation unit thermostat unit comprises a separation unit receiving space and a Peltier-element which is thermally coupled with the thermal coupling unit, and the Peltier-element is configured to adjust the temperature of the separation unit in the separation unit receiving space.

14. The thermostat arrangement according to claim 1, wherein the sample handling unit thermostat unit comprises:
a sample handling unit receiving space which is receiving the sample handling unit, which is thermally coupled with a fluid path along which a working fluid circulates;
an evaporator unit configured to evaporate the working fluid, wherein the evaporator unit is thermally coupled with the sample handling unit receiving space;
a liquefier unit configured to liquefy the working fluid which is evaporated in the evaporator unit;
a compressor unit configured to compress the working fluid which flows from the evaporator unit in the direction of the liquefier unit; and
an expansion unit configured to expand the working fluid which flows from the liquefier unit in the direction of the evaporator unit,
wherein the liquefier unit and/or the evaporator unit is or are thermally coupled with the thermal coupling unit.

15. The thermostat arrangement according to claim 1, wherein the thermal coupling unit comprises at least one control element configured to control a thermal coupling between the separation unit thermostat unit and the sample handling unit thermostat unit.

16. The thermostat arrangement according to claim 1, wherein the thermal coupling unit is configured to constantly or dynamically thermally couple or decouple the separation unit thermostat unit and the sample handling unit thermostat unit.

17. The thermostat arrangement according to claim 1, comprising a control unit configured to control the thermal coupling unit for thermally coupling the separation unit thermostat unit with the sample handling unit thermostat unit according to a pregiven control algorithm, wherein the control unit is configured to control the thermal coupling unit for adjusting an operation point to a target operation point of the separation unit thermostat unit and/or of the sample handling unit thermostat unit.

18. A sample separation device for separating a fluidic sample, the sample separation device comprising:
a fluid drive configured to drive a mobile phase and the fluidic sample which is located therein;
a thermostat arrangement according to claim 1;
a separation unit which is temperable by the separation unit thermostat unit and is configured to separate the fluidic sample in the mobile phase; and
a sample handling unit which is temperable by the sample handling unit thermostat unit and is configured to handle the fluidic sample.

19. The sample separation device according to claim 18, further comprising at least one of the following features:
wherein the sample handling unit comprises a sample insertion unit for inserting the fluidic sample in a fluidic path between the fluid drive and the separation unit;
wherein the sample handling unit comprises a sample storing unit for storing the fluidic sample;
the separation unit is configured as a chromatographic separation unit or a chromatography separation column;
the sample separation device is configured for analyzing at least one physical, chemical and/or biological parameter of at least one fraction of the fluidic sample;
the sample separation device comprises at least one selected from the group consisting of: a device for a chemical, biological and/or pharmaceutical analysis; a chromatography device; a liquid chromatography device; a gas chromatography device; a device for supercritical liquid chromatography; an HPLC-device; and a UHPLC-device;
the fluid drive is configured for driving the mobile phase with a pressure of at least 100 bar;
the fluid drive is configured for driving the mobile phase with a pressure of at least 500 bar;
the fluid drive is configured for driving the mobile phase with a pressure of at least 1000 bar;
the sample separation device is configured as a microfluidic device;
the sample separation device is configured as a nanofluidic device;
the sample separation device comprises a detector for detecting the separated fluidic sample;
the sample separation device comprises a sample fractionator for fractionizing the separated fluidic sample.

20. A method for separating a fluidic sample, the method comprising:
handling the fluidic sample using a sample handling unit which is tempered by a sample handling unit thermostat unit;
driving a mobile phase and the fluidic sample which is located therein by a fluid drive;
separating the fluidic sample in the mobile phase using a separation unit which is tempered by a separation unit thermostat unit; and
thermally coupling the separation unit thermostat unit with the sample handling unit thermostat unit.
